(19) United States
(12) Patent Application Publication
(10) Pub. No.: US 2024/0284909 A1
(43) Pub. Date: Aug. 29, 2024

(54) POUR-ON FORMULATION FOR CONTROLLING PESTS IN ANIMALS

(71) Applicant: Control Solutions, Inc., Pasadena, TX (US)

(72) Inventors: Douglas Harold Ross, Pasadena, TX (US); J Chance Peck-Pearce, Pasadena, TX (US); Marie Ann Knox, Houston, TX (US); John Carespodi, Deer Park, TX (US)

(73) Assignee: Control Solutions, inc., Pasadena, TX (US)

(21) Appl. No.: 18/586,014

(22) Filed: Feb. 23, 2024

Related U.S. Application Data
(60) Provisional application No. 63/486,659, filed on Feb. 23, 2023.

(51) Int. Cl. A01N 43/88; A01P 7/04

(52) U.S. Cl. CPC A01N 43/88; A01P 7/04

(57) ABSTRACT

Formulations and methods for efficiently and safely controlling pests in animals are disclosed.

### CROSS-REFERENCE TO RELATED APPLICATION

This application claims the benefit of U.S. Provisional Application No. 63/486,659, filed Feb. 23, 2023, the disclosure of which is hereby expressly incorporated by reference herein in its entirety.

### FIELD OF THE INVENTION

The present disclosure provides pour-on formulations comprising voltage-dependent sodium channel blockers and/or methods of controlling pest infestations in animals using the formulations.

### BACKGROUND OF THE INVENTION

Horn flies are the most significant insect pest of pastured cattle in the United States, causing losses of >$1 billion dollars annually. Their constant blood feeding causes substantial economic loss due to irritation, stress, and blood loss. Cattle battle flies instead of grazing, which reduces weight gain in stocker cattle, calf weaning weights, milk production, and can hinder bulls from breeding.

There are currently no effective treatments or methods of controlling pests of cattle, such as horn flies. Insecticidal ear tags are a popular means of horn fly control. The different types of tags include but are not limited to organophosphate tags, pyrethroid tags, macrocyclic lactone tags, and combination tags. Examples of organophosphate tags manufactured by Y-Tex include Max 40™ (active ingredient diazinon 40%), OPtimizer® (active ingredient diazinon 21%), and Warrior™ (active ingredients diazinon 30% and chlorpyrifos 10%), by Elanco include Corathon® (active ingredients diazinon 30% and chlorpyrifos 20%) and Patriot™ (active ingredient diazinon 40%), and by Merck include Dominator® (active pirimiphos-methyl 20%). Examples of pyrethroid tags manufactured by Y-Tex include GardStar® (active ingredient permethrin 10%), PYthon® (active ingredient zeta-cypermethrin 10%, PBO 20%), and PYthon® Magnum (active ingredient zeta-cypermethrin 10%, PBO 20%), by Elanco include CyLence® Ultra (beta-cyfluthrin 8%, PBO 20%) and Patriot™ (active ingredient diazinon 40%), and by Merck include Saber® Extra (active λ-cyhalothrin 10%, PBO 13%). Example of macrocyclic lactone tag manufactured by Y-Tex includes XP 820® with active ingredient abamectin 8%, PBO 20%. Example of combination tags manufactured by Y-Tex includes Tri-Zap™ (active ingredients abamectin 6%, zeta-cypermethrin 3.2%, PBO 20% and Merck include Double Barrel® VP (active ingredients pirimiphos-methyl 14%, A-cyhalothrin 6.8%). However, resistance in horn flies to the pesticides in the ear tags and regulatory issues now limit their effective use.

Currently available pour-on (PO) formulations face similar challenges. All EPA registered PO's for horn fly control on cattle contain pyrethroids to which horn flies are now resistant. For example, PO formulations manufactured by Elanco include Clean-Up™ II, CyLence®, Permectrin™ CDS, Permectrin™, and Permectrin™ S with active ingredients(s) permethrin 5% and diflubenzuron 5%, cyfluthrin 1%, permethrin 7.4% and PBO 7.4%, permethrin 1%, and permethrin 1% and PBO 1% respectively. PO formulations manufactured by Control Solutions include Cyonara®, Cyonara® Plus, Fly-Ban, Lice-Ban™, Permethrin® 1%, and Permethrin 1% Synergized containing active ingredients lambda-cyhalothrin 1%, lambda-cyhalothrin 1% and PBO 5%, permethrin 1% and PBO 1%, permethrin 5% and diflubenzuron 3%, permethrin 1%, and permethrin 1% and PBO 1% respectively. PO formulations manufactured by Merck include Boss®, Ultra Boss®, Saber®, Ultra Saber®, and Synergized® DeLice with active ingredients permethrin 5%, permethrin 5% & PBO 5%, lambda-cyhalothrin 1%, lambda-cyhalothrin 1% & PBO 5%, and permethrin 1% & PBO 1% respectively. PO formulations manufactured by Neogen include StandGuard™, Prozap® Backrubber & PO, Prozap® Backrubber & PO Extra, and Prozap® Insectrin CS with active ingredients gamma-cyhalothrin 0.5%, permethrin 0.125%, permethrin 0.125% & PBO 0.125%, permethrin 1% & PBO 1%, and permethrin 7.4% & PBO 7.4% respectively. PO formulations manufactured by Star Bar include Cattle Armor™ and Inhibidor™ with active ingredients permethrin 1% and PBO 1%, lambda-cyhalothrin 1% & PBO 5% & diflubenzuron 3% respectively. PO formulations manufactured by Y-Tex include Brute® with active ingredient permethrin 10%.

Currently, no PO formulations are available without pyrethroids, and EPA will not register one in the current (and future) regulatory environment. Producers' only rotational options are endectocides (e.g. ivermectin, moxidectin), which have some activity against horn flies, but have their own resistance issues.

Accordingly, there is a need for pesticidal formulations that can be used for safe and effective control of horn flies and other animal pests.

### SUMMARY OF THE INVENTION

One aspect of the present disclosure encompasses a pour-on formulation for control of pests on animals. The pour-on formulation comprises a pesticidal effective amount of a voltage-dependent sodium channel blocker, a paraffinic oil, and optionally a surface acting agent, a rheology modifier, or both.

The pesticidal effective amount of voltage-dependent sodium channel blocker in the formulation may range from about 5% to about 50% by weight. The voltage-dependent sodium channel blocker may be indoxacarb. The pesticidal effective amount of indoxacarb may range from about 5% to about 15% by weight.

The paraffinic oil may be a normal paraffin, an isoparaffin, a cycloparaffin, a highly refined paraffinic mineral oil, a solvent dewaxed light and/or heavy paraffinic distillate, or mixtures thereof. The paraffinic oil can be an isoparaffin. Alternatively, the paraffinic oil can be a mixture of hydrotreated isoparaffins and naphthenics. The amount of hydrotreated isoparaffins and naphthenics in the formulation may range from about 85% to about 95% by weight. The paraffinic oil may be SASOL LPA 210.

The surface acting agent can be an oil-soluble surfactant. The amount of oil-soluble surfactant in the formulation can range from about 0.5% to about 2% by weight. The surface acting agent can be Tomadol 23-5.

The rheological modifier can be fumed metal oxide. The fumed metal oxide can be fumed silicon oxide. The fumed metal oxide may be hydrophobic/hydrophilic fumed silicon oxide. The amount of fumed silicon oxide in the formulation may range from about 1.0% to about 5.0% by weight. The fumed metal oxide can be CAB-O-SIL.

The animal can be cattle. The pests can be ectoparasites. The pests can be horn flies.

The formulation may comprise indoxacarb in an amount ranging from about 5% to about 50% by weight; a mixture of hydrotreated isoparaffins and naphthenics in an amount ranging from about 85% to about 95% by weight; an oil-soluble surfactant in an amount ranging from about 0.5% to about 2% by weight; and fumed silicon oxide in an amount ranging from about 1.0% to about 5.0% by weight.

An additional aspect of the present disclosure encompasses a method of controlling pest infestations in animals. The method comprises pouring onto the external skin of the animal to be treated an effective amount of the pour-on formulation for control of pests on animals. The formulation is capable of diffusing over the body of the domestic animal when applied to a localized region of the domestic animal, thereby protecting the animal from pests.

Yet another aspect of the present disclosure encompasses a kit for controlling pests in animals. The kit comprises the pour-on formulation for control of pests on an animal.

### BRIEF DESCRIPTION OF THE DRAWINGS

FIG. 1 is a table showing the schedule of events.

FIG. 2 shows potential sites to be evaluated in cattle.

FIG. 3 is a pictorial representation of the cattle lice species.

### DETAILED DESCRIPTION

The present disclosure is based in part on the discovery of pour-on (PO) pesticidal formulations and methods of using the formulations to control populations of pests in animals. The formulations can provide effective and safe control of animal pests such as horn fly and lice. The compositions and methods of using the compositions are described further below.

### I. Formulation

One aspect of the present disclosure encompasses a pour-on formulation for control of pests on animals. The formulation comprises a pesticidal effective amount of a voltage-dependent sodium channel blocker and a paraffinic oil. The formulation can optionally further comprise a surface acting agent, a rheology modifier, or both.

In particular, the formulations of this invention are effective against ectoparasites including: flies such as Haematobia (Lyperosia) irritans (horn fly), Stomoxys calcitrans (stable fly), Simulium spp. (blackfly), Glossina spp. (tsetse flies), Hydrotaea irritans (head fly), Musca autumnalis (face fly), Musca domestica (house fly), Morellia simplex (sweat fly), Tabanus spp. (horse fly), Hypoderma bovis, Hypoderma lineatum, Lucilia sericata, Lucilia cuprina (green blowfly), Calliphora spp. (blowfly), Protophormia spp., Oestrus ovis (nasal botfly), Culicoides spp. (midges), Hippobosca equine, Gastrophilus instestinalis, Gastrophilus hemorrhoidalis and Gastrophilus naslis; lice such as Bovicola (Damalinia) bovis, Bovicola equi, Haematopinus asini, Felicola subrostratus, Heterodoxus spiniger, Lignonathus setosus and Trichodectes canis; keds such as Melophagus ovinus; mites such as Psoroptes spp., Sarcoptes scabei, Chorioptes bovis, Demodex equi, Cheyletiella spp., Notoedres cati, Trombicula spp. and Otodectes cyanotis (ear mites); ticks such as Ixodes spp., Boophilus spp., Rhipicephalus spp., Amblyomma spp., Dermacentor spp., Hyalomma spp. and Haemaphysalis spp.; and fleas such as Ctenocephalides felis (cat flea) and Ctenocephalides canis (dog flea).

### i) Voltage-Dependent Sodium Channel Blocker

Insecticidal compounds acting as sodium channel modulators disrupt the normal functioning of voltage-dependent sodium channels in insects, which causes rapid paralysis or knock-down following application of these insecticides. The sodium channel modulators have been grouped together based on their chemical structural similarity into four classes, including pyrethroids, non-ester pyrethroids, oxadiazines and natural pyrethrins. The pyrethroids include allethrin, alpha-cypermethrin, beta-cyfluthrin, beta-cypermethrin, bifenthrin, cyfluthrin, cyhalothrin, cypermethrin, deltamethrin, esfenvalerate, fenfluthrin, fenpropathrin, fenvalerate, flucythrinate, gamma-cyhalothrin, lambda-cyhalothrin, metofluthrin, permethrin, profluthrin, resmethrin, tau-fluvalinate, tefluthrin, tetramethrin, tralomethrin, transfluthrin and zeta-cypermethrin. The non-ester pyrethroids include etofenprox, flufenprox, halfenprox, protrifenbute and silafluofen. The oxadiazines include indoxacarb. The natural pyrethrins include cinerin-I, cinerin-II, jasmolin-I, jasmolin-II, pyrethrin-I and pyrethrin-II.

Indoxacarb and metaflumizone represent a new class of sodium channel-targeting insecticides with a mode of action distinct from that of DDT and pyrethroids. They inhibit sodium current and are known as sodium channel blocker insecticides, or sodium channel inhibitors. In insects, indoxacarb is metabolically converted to N-decarbomethoxyllated JW062 (DCJW), a more active metabolite, whereas mammals convert indoxacarb into nontoxic metabolites. This difference in metabolism contributes to the selective toxicity of indoxacarb to insect pests.

The pesticidal effective amount of voltage-dependent sodium channel blocker in the formulation can range from about 5% to about 50% by weight, from about 6% to about 49% by weight, from about 7% to about 48% by weight, from about 8% to about 47% by weight, from about 9% to about 46% by weight, from about 10% to about 45% by weight, from about 11% to about 44% by weight, from about 12% to about 43% by weight, from about 13% to about 42% by weight, from about 14% to about 41% by weight, from about 15% to about 40% by weight, from about 16% to about 39% by weight, from about 17% to about 38% by weight, from about 18% to about 37% by weight, from about 19% to about 36% by weight, from about 20% to about 35% by weight, from about 21% to about 34% by weight, from about 22% to about 33% by weight, from about 23% to about 32% by weight, from about 24% to about 31% by weight, from about 25% to about 30% by weight, from about 26% to about 29% by weight, or from about 27% to about 28% by weight.

Voltage dependent sodium channel blockers include but are not limited to indoxacarb and metaflumizone.

In some embodiments, the voltage-dependent sodium channel blocker is indoxacarb. In one aspect, the pesticidal effective amount of indoxacarb ranges from about 5% to about 15% by weight. In other aspects, the pesticidal effective amount of indoxacarb ranges from about 6% to about 14% by weight, from about 6% to about 13% by weight, from about 7% to about 12% by weight, from about 8% to about 11% by weight, or from about 9% to about 10% by weight.

### ii) Paraffinic Oil

The paraffinic oil includes any oil enriched in paraffin. In one embodiment, the paraffin has a number of carbon atoms ranging from about 12 to about 50 (C12 to C50) or combinations thereof, and preferably with a carbon number ranging from about C16 to about C35 and with an average carbon number of about C23. Preferably, the paraffin content of the paraffinic oil is at least about 80%, and more preferably at least about 90%, and most preferably at least about 99%.

The paraffinic oil can be a normal paraffin, an isoparaffin, a cycloparaffin, a highly refined paraffinic mineral oil, a solvent dewaxed light and/or heavy paraffinic distillate, or mixtures thereof. In some embodiments, the paraffinic oil is an isoparaffin.

In other embodiments, the paraffinic oil is a mixture of hydrotreated isoparaffins and naphthenics. The amount of hydrotreated isoparaffins and naphthenics in the formulation can range from about 85% to about 95% by weight, from about 86% to about 94% by weight, from about 87% to about 93% by weight, from about 88% to about 92% by weight, or from about 89% to about 91% by weight. In some aspects, the paraffinic oil is SASOL LPA 210.

iii) Surfactant

The surfactant can be anionic, cationic surfactants, zwitterionic surfactants, and non-ionic surfactants. Anionic surfactants can be sulfate, sulfonate, and phosphate, carboxylate derivatives. Non-limiting examples of anionic surfactants include ammonium lauryl sulfate, sodium lauryl sulfate (sodium dodecyl sulfate, SLS, or SDS), and the related alkyl-ether sulfates sodium laureth sulfate (sodium lauryl ether sulfate or SLES), and sodium myreth sulfate, (dioctyl docusate sodium sulfosuccinate), perfluorooctanesulfonate (PFOS), perfluorobutanesulfonate, alkyl-aryl ether phosphates, alkyl ether phosphates, sodium stearate, sodium lauroyl sarcosinate and carboxylate-based fluorosurfactants such as perfluorononanoate, and perfluorooctanoate (PFOA or PFO). Non-limiting examples of cationic surfactants include octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB). Non-limiting examples of zwitterionic surfactants include CHAPS (3-[(3-cholamidopropyl)dimethylammonio]-1-propanesulfonate), lauryldimethylamine oxide, and myristamine oxide. Suitable non-ionic surfactants include emulsifying wax, glyceryl monooleate, polyoxyethylene alkyl ethers, polyoxyethylene castor oil derivatives, polysorbate, sorbitan esters, benzyl alcohol, benzyl benzoate, cyclodextrins, glycerin monostearate, poloxamer, povidone and combinations thereof. In one embodiment, the non-ionic surfactant is stearyl alcohol. Non-limiting examples of non-ionic surfactants include octaethylene glycol monododecyl ether, pentaethylene glycol monododecyl ether, nonoxynols, Triton X-100, polyethoxylated tallow amine, cocamide monoethanolamine, cocamide diethanolamine, polaxamers, glycerol monostearate, glycerol monolaurate, sorbitan monolaurate, sorbitan monostearate, sorbitan tristearate, Tween 20, Tween 40, Tween 60, Tween 80, decyl glucoside, lauryl glucoside, octyl glucoside, siloxane surfactants, and combinations thereof.

In some embodiments, the surfactant may be an oil-soluble surfactant. In some aspects, the amount of oil-soluble surfactant in the formulation ranges from about 0.5% to about 2% by weight, from about 0.6% to about 1.9% by weight, from about 0.7% to about 1.8% by weight, from about 0.8% to about 1.7% by weight, from about 0.9% to about 1.6% by weight, from about 1.0% to about 1.5% by weight. from about 0.5% to about 2% by weight, from about 0.6% to about 1.9% by weight. In one aspect, the surface acting agent is Tomadol 23-5.

iv. Rheological Modifier

The rheological modifier can be fumed metal oxide. For instance, the fumed metal oxide can be fumed silicon oxide. In some aspects, the fumed metal oxide is hydrophobic/hydrophilic fumed silicon oxide. In some aspects, the amount of fumed silicon oxide in the formulation ranges from about 1.0% to about 5.0% by weight, from about 1.5% to about 4.5% by weight, from about 2.0% to about 4.0% by weight, or from about 2.5% to about 3.5% by weight. In one aspect, the fumed metal oxide is CAB-O-SIL.

The animals can be cattle, and the pests can be ectoparasite pests. Ectoparasites such as ticks, mites, lice, flies, and fleas irritate the animals and can cause disease, either by themselves, or by carrying vector transmitted pathogens. In some aspects, the ectoparasite pests can be horn flies and lice. In some aspects, the animals are cattle, and the pests are horn flies. In other aspects, the animals are cattle, and the pests are lice.

The lice include biting, chewing, and sucking lice.

In some aspects, a pour-on formulation of the instant disclosure comprises indoxacarb in an amount ranging from about 5% to about 50% by weight; a mixture of hydrotreated isoparaffins and naphthenics in an amount ranging from about 85% to about 95% by weight; an oil-soluble surfactant in an amount ranging from about 0.5% to about 2% by weight; and fumed silicon oxide in an amount ranging from about 1.0% to about 5.0% by weight.

### II. Methods

Another aspect of the instant disclosure encompasses a method of treating pest infestations in animals. The method comprising pouring onto the external skin of the animal to be treated a pesticidally effective amount of a pour-on formulation for control of pests on animals, wherein the formulation is capable of diffusing over the body of the domestic animal when applied to a localized region of the domestic animal, thereby protecting the animal from pests. The formulation can be as described in Section I herein above.

A pesticidally effective amount may be determined by the efficacy or potency of the particular composition, the pest being controlled, the duration or frequency of application of the pesticidal composition, and the method of application of the composition. A pesticidally effective amount can be determined using methods known in the art and can be determined experimentally. Additionally, the method of application may be considered when determining the pesticidally effective amount. In determining pesticidally effective amounts, one skilled in the art may also consider the existence of resistance of the pest to pesticides. Importantly, the pest can be contacted at any stage of development of the pest. This is because the method can control current and future pest generations independent of application timing with respect to the life stage of the pest.

The animals can be cattle, and the pests can be ectoparasites such as horn flies and lice. In some aspects, the animals are cattle, and the pests are horn flies. In other aspects, the animals are cattle, and the pests are lice.

### III. Kits

A further aspect of the present disclosure provides kits comprising one or more formulations detailed above in Section I and/or unit doses of the formulations. The one or more formulations can be used to control pests on animals using methods described in Section II.

The kits provided herein generally include instructions for carrying out the methods detailed below. Instructions included in the kits may be affixed to packaging material or may be included as a package insert. While the instructions are typically written or printed materials, they are not limited to such. Any medium capable of storing such instructions and communicating them to an end user is contemplated by this disclosure. Such media include, but are not limited to, electronic storage media (e.g., magnetic discs, tapes, cartridges, chips), optical media (e.g., CD ROM), and the like.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

As used herein, the term “unit dose” refers to a dose of an effective amount of an active agent such as a formulation of the instant disclosure. The unit dose can be prepared in an individual packet for convenience, safety, or monitoring.

As various changes could be made in the above-described cells and methods without departing from the scope of the invention, it is intended that all matter contained in the above description and in the examples given below, shall be interpreted as illustrative and not in a limiting sense.

As used herein, the term “instructions” may include the address of an internet site that provides the instructions.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1. Control of Horn Flies on Cattle

Through “proof-of-concept” and “dose determination” studies, it was here demonstrated that indoxacarb is efficacious against horn flies on cattle. In short, cattle were infested with horn flies, and either treated with an indoxacarb pour on (PO) formulation (Table 1) or a control. The number of files remaining after a certain period were then counted. As is shown in Table 2 and Tables 3 and 4, the PO formulation provided more than 90% control of horn flies.

TABLE 1
Pour on formulation

| Ingredient | % w/w |
|---|---|
| Indoxacarb (91.8%) | 8.7146 |
| SASOL LPA 210 | 87.2854 |
| Tomadol 23-5 | 1.000 |
| CAB-O-SIL | 3.000 |

TABLE 2
Mean horn fly counts and percent reduction for
treated cattle (compared to untreated controls).
Means on the same day followed by
different letters indicate a significant
difference between the treatments (p < 0.05).

| Study | | Mean Fly | % |
|---|---|---|---|
| Day | Treatment | Counts | Control |
| 2 | Control | 107 | 90% |
| | Indox PO | 11 | |
| 5 | Control | 78 | 92% |
| | Indox PO | 6.4 | |
| 8 | Control | 81 | 97% |
| | Indox PO | 2.8 | |

TABLE 3
Mean horn fly survival and percent horn fly control (corrected
for control group) for each treatment group at each post-
treatment time point. For each day, BOLD means are
significantly different (p < 0.05) from the control.
Mean Horn Fly Survival (95% CI)

| | Days after Treatment | | | | |
|---|---|---|---|---|---|
| Treatment | 2 | 8 | 15 | 22 | 29 |
| Untreated Control | 51% | 54% | 60% | 53% | 56% |
| 8% indoxacarb | 8.4% | 0.5% | 0.2% | 3.9% | 9.5% |
| solution | | | | | |
| 7% indoxacarb | 2.4% | 0.2% | 0.6% | 2.6% | 8.5% |
| solution | | | | | |
| 8% indoxacarb | 0.3% | 0.1% | 3.3% | 6.9% | 9.0% |
| suspension | | | | | |

% Horn Fly Control

| | Days after Treatment | | | | |
|---|---|---|---|---|---|
| Treatment | 2 | 9 | 15 | 22 | 29 |
| 8% indoxacarb | 84% | 99% | 99.7% | 93% | 83% |
| solution | | | | | |
| 7% indoxacarb | 95% | 99.6% | 99% | 95% | 85% |
| solution | | | | | |
| 8% indoxacarb | 99% | 99.8% | 95% | 87% | 84% |
| suspension | | | | | |

TABLE 4
Cumulative total numbers of horn flies recovered from all five animals in
each treatment group and overall percent reduction in horn fly survival*.

| | | | | | | | Overall Reduction |
|---|---|---|---|---|---|---|---|
| | Days after Treatment | | | | | % | in Horn Fly Survival |
| Treatment | 2 | 8 | 15 | 22 | 29 | Survival | (=control) |
| Untreated Control | 510 | 1,046 | 1,643 | 2,170 | 2,729 | 55% | — |
| 8% solution | 84 | 89 | 91 | 130 | 225 | 5% | 92% |
| 7% solution | 24 | 26 | 32 | 58 | 143 | 3% | 95% |
| 8% suspension | 3 | 4 | 37 | 106 | 196 | 4% | 93% |

*The five animals in each group were infested with a total of 5,000 flies in the course of the study.

### Example 2. Control of Horn Flies on Cattle-Field Studies

Four field studies were conducted in three states [Missouri, Oklahoma, and Texas (2 studies)] to demonstrate that indoxacarb is efficacious against horn flies on cattle. Each study used three groups of cattle: one untreated group served as the control; a second group was treated with an 8% indoxacarb PO formulation; and the third group was treated with an EPA registered commercial PO (a different one for each study). These four commercial PO products each contained one of the four pyrethroid insecticides registered by the EPA for application to cattle for horn fly control. Horn flies on each animal were counted approximately one week prior to treatment and approximately weekly post-treatment for up to 8 weeks. As shown in Tables 6, 7, 8 and 9, the indoxacarb PO formulation provided ≥90% horn fly control for up to six weeks post-treatment. In all four studies, the efficacy of the indoxacarb PO was equal to or greater than the four pyrethroid pour-on formulations.

TABLE 5
shows the pour on formulation.

| Ingredient | % w/w |
|---|---|
| Indoxacarb (91.8%) | 8.7146 |
| SASOL LPA 210 | 87.2854 |
| Tomadol 23-5 | 1.000 |
| CAB-O-SIL | 3.000 |

Table 6 shows mean horn fly counts on cattle in the untreated control and two pour-on treated groups and percent fly control through eight weeks post-treatment. Study conducted in Texas from 17 May-19 Jul. 2023.

TABLE 6

| Weeks | | Mean no. | % Horn |
|---|---|---|---|
| Post- | | Horn flies/ | fly |
| treatment | Treatment | head | Control |
| | Control | 1,192 | n/a |
| −1 | 7.4% permethrin + 7.4% PBO | 1,124 | |
| | 8% indoxacarb | 1,062 | |
| | Control | 1,357 | |
| | 7.4% permethrin + 7.4% PBO | 15 | 99% |
| 1 | 8% indoxacarb | 14 | 99% |
| | Control | 1,464 | |
| 2 | 7.4% permethrin + 7.4% PBO | 30 | 98% |
| | 8% indoxacarb | 11 | 99% |
| | Control | 1,500 | |
| | 7.4% permethrin + 7.4% PBO | 60 | 96% |
| 3 | 8% indoxacarb | 10 | 99% |
| | Control | 1,009 | |
| | 7.4% permethrin + 7.4% PBO | 10 | 99% |
| 4 | 8% indoxacarb | 2 | 100% |
| | Control | 618 | |
| | 7.4% permethrin + 7.4% PBO | 20 | 97% |
| 5 | 8% indoxacarb | 6 | 99% |
| | Control | 620 | |
| | 7.4% permethrin + 7.4% PBO | 10 | 98% |
| 6 | 8% indoxacarb | 4 | 99% |
| | Control | 640 | |
| 7 | 7.4% permethrin + 7.4% PBO | 46 | 92% |
| | 8% indoxacarb | 70 | 88% |
| | Control | 728 | |
| 8 | 7.4% permethrin + 7.4% PBO | 158 | 77% |
| | 8% indoxacarb | 248 | 62% |

Table 7 shows mean horn fly counts on cattle in the untreated control and two pour-on treated groups and percent fly control through six weeks post-treatment. Study conducted in Missouri from 1 Jun.-20 Jul. 2023.

TABLE 7

| Weeks | | Mean no. | % Horn |
|---|---|---|---|
| Post- | | Horn flies/ | fly |
| treatment | Treatment | head | Control |
| | Control | 223 | n/a |
| −1 | 1% cyfluthrin | 237 | |
| | 8% indoxacarb | 247 | |
| | Control | 425 | |
| 1 | 1% cyfluthrin | 118 | 74% |
| | 8% indoxacarb | 23 | 95% |
| | Control | 385 | |
| 2 | 1% cyfluthrin | 134 | 67% |
| | 8% indoxacarb | 21 | 95% |
| 3 | Control | 211 | |
| | 1% cyfluthrin | 399 | 0% |
| | 8% indoxacarb | 127 | 45% |
| 4 | Control | 191 | |
| | 1% cyfluthrin | 324 | 0% |
| | 8% indoxacarb | 126 | 40% |
| 5 | Control | 105 | |
| | 1% cyfluthrin | 472 | 0% |
| | 8% indoxacarb | 215 | 0% |
| 6 | Control | 243 | |
| | 1% cyfluthrin | 329 | 0% |
| | 8% indoxacarb | 150 | 44% |

Table 8 shows mean horn fly counts on cattle in the untreated control and two pour-on treated groups and percent fly control through seven weeks post-treatment. Study conducted in Oklahoma from 17 Jun.-11 Aug. 2023.

TABLE 8

| Weeks | | Mean no. | % Horn |
|---|---|---|---|
| Post- | | Horn flies/ | fly |
| treatment | Treatment | head | Control |
| | Control | 1,230 | n/a |
| −1 | 1% lambda-cyhalothrin + 5% PBO | 1,200 | |
| | 8% indoxacarb | 1,200 | |
| | Control | 1,093 | |
| 1 | 1% lambda-cyhalothrin + 5% PBO | 20 | 98% |
| | 8% indoxacarb | 35 | 97% |
| | Control | 591 | |
| 2 | 1% lambda-cyhalothrin + 5% PBO | 20 | 96% |
| | 8% indoxacarb | 21 | 96% |
| | Control | 1,789 | |
| 3 | 1% lambda-cyhalothrin + 5% PBO | 68 | 96% |
| | 8% indoxacarb | 38 | 98% |
| | Control | 2,017 | |
| 4 | 1% lambda-cyhalothrin + 5% PBO | 118 | 94% |
| | 8% indoxacarb | 122 | 94% |
| 5 | Control | 2,484 | |
| | 1% lambda-cyhalothrin + 5% PBO | 249 | 90% |
| | 8% indoxacarb | 378 | 84% |
| | Control | 2,435 | |
| 6 | 1% lambda-cyhalothrin + 5% PBO | 727 | 69% |
| | 8% indoxacarb | 338 | 86% |
| 7 | Control | 2,484 | |
| | 1% lambda-cyhalothrin + 5% PBO | 939 | 61% |
| | 8% indoxacarb | 584 | 76% |

Table 9 shows mean horn fly counts on cattle in the untreated control and two pour-on treated groups and percent fly control through five weeks post-treatment. Second study conducted in Texas from 23 Aug.-4 Oct. 2023.

TABLE 9

| Weeks | | Mean no. | % Horn |
|---|---|---|---|
| Post- | | Horn flies/ | fly |
| treatment | Treatment | head | Control |
| | Control | 2,056 | n/a |
| −1 | 0.5% gamma-cyhalothrin | 2,084 | |
| | 8% indoxacarb | 2,058 | |
| | Control | 2,140 | |
| 1 | 0.5% gamma-cyhalothrin | 50 | 98% |
| | 8% indoxacarb | 221 | 90% |
| | Control | 2,070 | |
| 2 | 0.5% gamma-cyhalothrin | 412 | 80% |
| | 8% indoxacarb | 45 | 98% |
| | Control | 3,000 | |
| 3 | 0.5% gamma-cyhalothrin | 630 | 79% |
| | 8% indoxacarb | 206 | 93% |
| | Control | 3,018 | |
| 4 | 0.5% gamma-cyhalothrin | 1,018 | 67% |
| | 8% indoxacarb | 1,090 | 64% |
| 5 | Control | 3,080 | |
| | 0.5% gamma-cyhalothrin | 2,990 | 4% |
| | 8% indoxacarb | 3,000 | 3% |

### Example 3. Control of Lice on Cattle-Field Study

A field study was conducted in Idaho from 7 Dec. 2022 through 8 Feb. 2023, to demonstrate that indoxacarb is efficacious against chewing and sucking lice on cattle. This study used two groups of cattle: one untreated group served as the control; a second group was treated with an 8% indoxacarb PO formulation. Lice on each animal were counted 2 days prior to treatment and approximately weekly post-treatment for 8 weeks.

Table 10 shows mean total louse counts, louse survival (compared to pretreatment counts) and 8% indoxacarb pour-on efficacy on treated cattle. Study conducted in Idaho from 7 Dec. 2022-8 Feb. 2023.

As shown in Table 10, the 8% indoxacarb PO formulation provided >98% louse control for eight weeks post-treatment.

TABLE 10
Mean total louse counts, louse survival (compared to pretreatment
counts) and 8% indoxacarb pour-on efficacy on treated cattle.
Study conducted in Idaho from 7 DEC. 2022-8 FEB. 2023.

| Study | Mean Louse Counts | | Louse Survival | | 8% Indoxacarb |
|---|---|---|---|---|---|
| Day | Control | CSI 19-305 | Control | 8% Indoxacarb | Efficacy |
| −2 | 87 | 87 | — | — | — |
| 7 | 99 | 0 | 125% | 0% | 100% |
| 14 | 52 | 0 | 67% | 1% | 100% |
| 21 | 82 | 0 | 101% | 0% | 100% |
| 28 | 49 | 0 | 62% | 0% | 100% |
| 35 | 131 | 0.1 | 151% | 0.1% | 99.9% |
| 42 | 86 | 0.2 | 100% | 0.3% | 99.8% |
| 49 | 87 | 1.6 | 106% | 1.8% | 98.3% |
| 55 | 117 | 1.6 | 174% | 1.9% | 98.3% |

### Example 4. Control of Lice on Cattle-Field Study

A field study was conducted in Idaho from 7 Dec. 2022, through 8 Feb. 2023, to demonstrate that indoxacarb is efficacious against biting (Mallophaga) and sucking (Anoplura) lice on cattle. This study used two groups of cattle: one untreated group served as the control; a second group was treated with an 8% indoxacarb PO formulation. Lice on each animal were counted 2 days prior to treatment and approximately weekly post-treatment for 8 weeks.

Observations were made at 1 and 6 hours following test substance application on study day (SD) 0 and daily thereafter for the duration of the study.

Infestations consisted of natural louse populations on the study animals: biting lice (Mallophaga)-cattle biting louse Bovicola (Damalinia) bovis and sucking lice (Anoplura)-long-nosed cattle louse Linognathus vituli.

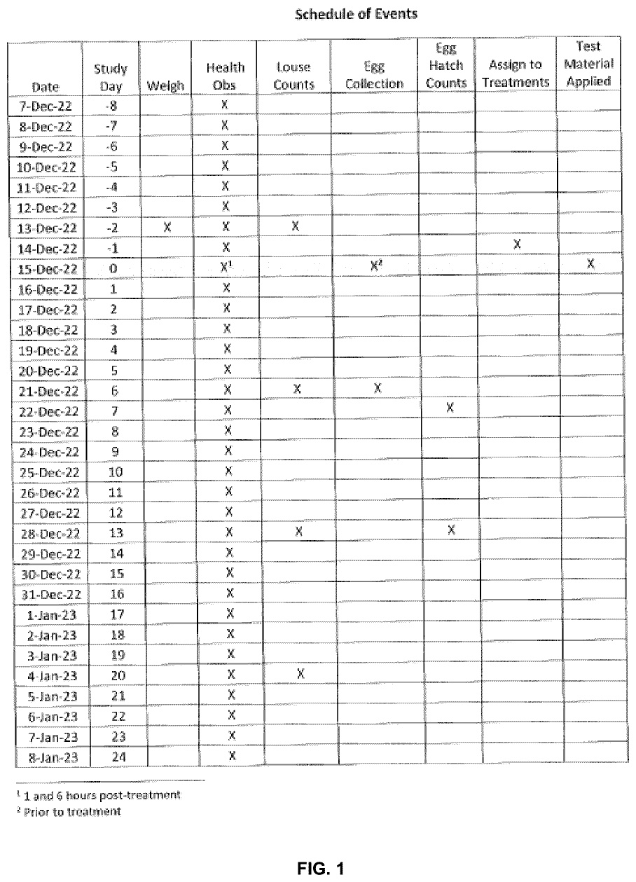

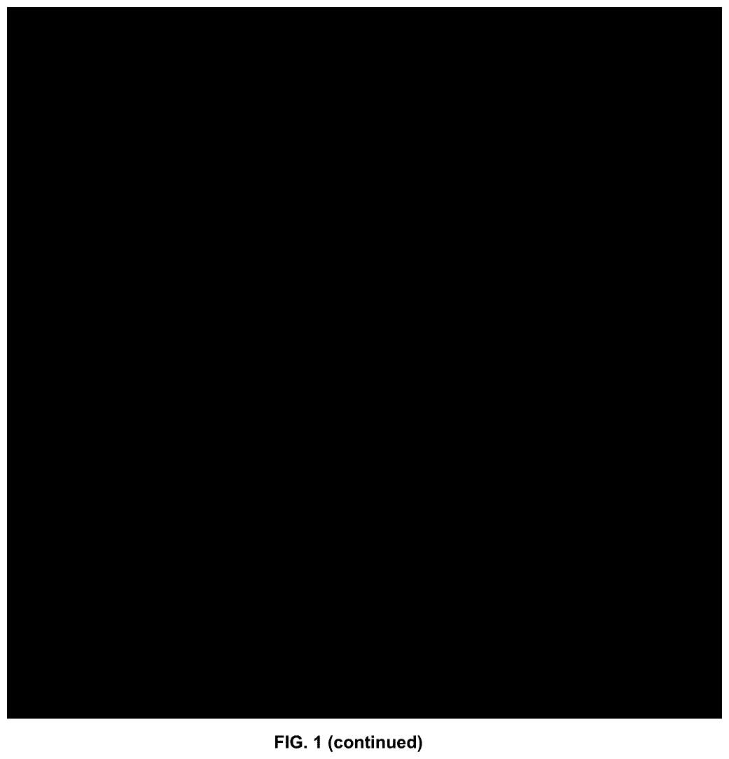

Pre- and post-treatment louse counts were performed on all animals in groups A and B at the times shown in the schedule of events in FIG. 1.

Examinations of cattle for lice at weekly intervals for eight weeks after treatment assured an accurate estimation of louse burdens in efficacy studies. This observation period covered at least two complete life cycles of the lice and allowed monitoring the population dynamics of the lice, which multiply on the host.

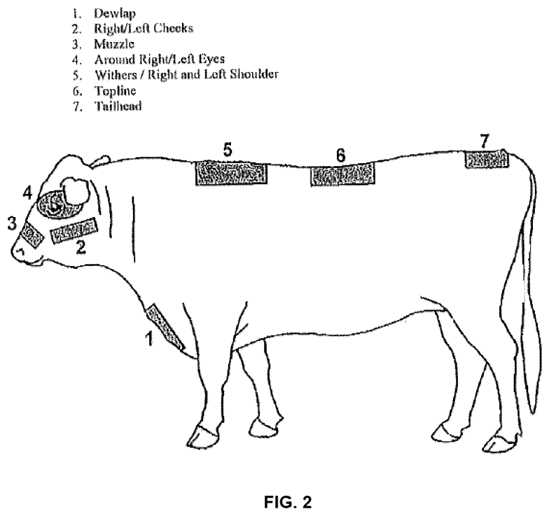

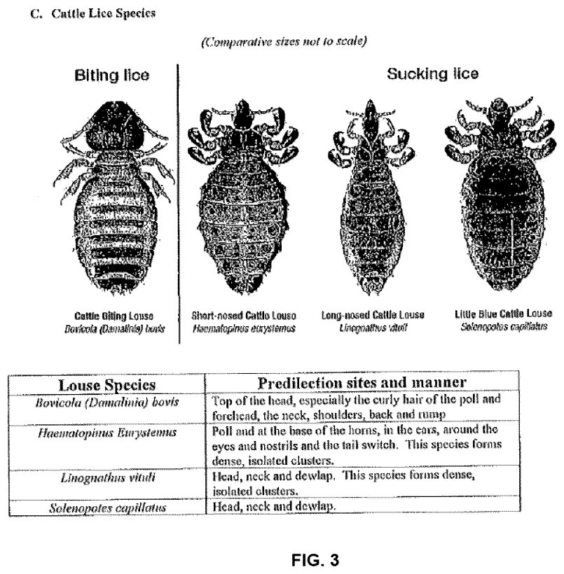

As shown in FIG. 2, lice were counted on the left and right cheeks, withers, topline, tailhead and around the left and right eyes. For each animal on each date, the numbers of each louse species from all seven locations were summed to give that animal's louse count. The cattle lice species are shown in FIG. 3.

To evaluate the ovicidal activity of the test substance, hair containing louse eggs was collected from treated and untreated cattle, incubated, and the eggs examined for hatching. The three animals in each treatment group (total n=6) which had the highest pre-treatment louse counts were used for these collections. Eggs were collected on: (1) SD 0 prior to test substance application; and (2) SD 6, during the first post-treatment louse counts. No attempt was made to identify the species of eggs collected. Based on the relative abundance of louse species counted during the study, the majority of eggs collected were probably B. bovis.

All the hair collected from each animal was put into a suitable container labeled with the group identifier (Pen 139 or 141), animal number, date and returned to the laboratory. On collection days, louse eggs (on hair) from each animal were placed in Petri dishes (approximately 25 eggs per dish), labeled with pen number, animal number, collection date, and replicate number. Every attempt was made to locate enough eggs (n=100) to have four replicates per animal of 25 eggs at both pretreatment and post-treatment collections. On SD 0, animal 21 (control group A) only had 3 replicates of 25 able to be identified. Petri dishes were incubated at 95° F.±5° F. (35° C.±3° C.) and 70-90% relative humidity. These conditions were monitored with a chart recorder that captured humidity and temperature.

Seven days after each collection (SD's 7 and 13, respectively), the incubated eggs were examined under a microscope, and the numbers of unhatched and hatched eggs and louse nymphs observed in each replicate were counted and recorded.

The study terminated after eighth post-treatment louse counts and final animal weights on 8 Feb. 2023 (SD 55).

Pretreatment infestations of louse Bovicola bovis was similar in both groups (Table 11). The test achieved 100% efficacy against B. bovis from SD 7 through SD 55.

TABLE 11
Least squares mean Bovicola bovis counts, survival
(compared to pretreatment counts) and efficacy on treated
cattle (with 95% confidence intervals). Study conducted
in Idaho from 7 Dec. 2022-8 Feb. 2023.
COUNTS

| | Control | | | CSI 19-305 | | |
|---|---|---|---|---|---|---|
| Study | Mean | 95% CI's | | Mean | 95% CI's | |
| Day | Counts | Lower | Upper | Counts | Lower | Upper |
| −2 | 85 | 62 | 118 | 87 | 63 | 120 |
| 7 | 97 | 71 | 134 | 0 | — | — |
| 14 | 51 | 37 | 71 | 0 | — | — |
| 21 | 82 | 59 | 113 | 0 | — | — |
| 28 | 49 | 35 | 68 | 0 | — | — |
| 35 | 129 | 94 | 178 | 0 | — | — |
| 42 | 85 | 62 | 118 | 0 | — | — |
| 49 | 81 | 59 | 112 | 0 | — | — |
| 55 | 114 | 83 | 157 | 0 | — | — |

SURVIVAL & EFFICACY

| Study | Control | CSI 19-305 | CSI 19-305 | 95% CI's | 95% CI's |
|---|---|---|---|---|---|
| Day | Survival | Survival | Efficacy | Lower | Upper |
| 7 | 125% | 0% | 100% | — | — |
| 14 | 67% | 0% | 100% | — | — |
| 21 | 101% | 0% | 100% | — | — |
| 28 | 63% | 0% | 100% | — | — |
| 35 | 150% | 0% | 100% | — | — |
| 42 | 100% | 0% | 100% | — | — |
| 49 | 99% | 0% | 100% | — | — |
| 55 | 170% | 0% | 100% | — | — |

Pretreatment infestations of louse Linognathus vitulo was similar in both groups (Table 12), but lower than those for B. bovis. The test substance's efficacy against this sucking louse was 100% from SD 7 through SD 28, >99% through SD 42, and >98% through SD 55 efficacy against B. bovis from study day (SD) 7 through SD 55.

TABLE 12
Least squares mean Linognathus vitulo counts, survival
(compared to pretreatment counts) and efficacy on treated
cattle (with 95% confidence intervals). Study conducted
in Idaho from 7 Dec. 2022-8 Feb. 2023.
COUNTS

| | Control | | | CSI 19-305 | | |
|---|---|---|---|---|---|---|
| Study | Mean | 95% CI's | | | 95% CI's | |
| Day | Counts | Lower | Upper | Mean | Lower | Upper |
| −2 | 0.98 | 0.47 | 2.02 | 0.4 | 0.2 | 1.3 |
| 7 | 1.53 | 0.79 | 2.96 | 0.0 | — | — |
| 14 | 0.24 | 0.08 | 0.75 | 0.0 | — | — |
| 21 | 0.24 | 0.08 | 0.75 | 0.0 | — | — |
| 28 | 0.12 | 0.03 | 0.55 | 0.0 | — | — |
| 35 | 1.10 | 0.54 | 2.23 | 0.1 | 0.0 | 0.7 |
| 42 | 0.18 | 0.05 | 0.65 | 0.2 | 0.0 | 0.8 |
| 49 | 4.41 | 2.47 | 7.85 | 1.5 | 0.7 | 3.1 |
| 55 | 2.25 | 1.19 | 4.23 | 1.5 | 0.7 | 3.1 |

SURVIVAL & EFFICACY

| Study | Control | CSI 19-305 | CSI 19-305 | 95% CL's | 95% CL's |
|---|---|---|---|---|---|
| Day | Survival | Survival | Efficacy | Lower | Upper |
| 7 | 156% | 0% | 100% | — | — |
| 14 | 25% | 0% | 100% | — | — |
| 21 | 19% | 0% | 100% | — | — |
| 28 | 13% | 0% | 100% | — | — |
| 35 | 38% | 0% | 99.9% | 99.2% | 100.0% |
| 42 | 0% | 0% | 99.8% | 99.1% | 100.0% |
| 49 | 13% | 40% | 98.3% | 96.9% | 99.1% |
| 55 | 50% | 20% | 98.3% | 96.9% | 99.1% |

Pretreatment total louse infestations were similar in both groups (Table 13). The test substance achieved 100% efficacy against all lice from SD 7 through SD 28. For the remainder of the study efficacy remained >98%.

TABLE 13
Least squares mean total louse counts, survival (compared to pretreatment
counts) and efficacy on treated cattle (with 95% confidence intervals).
Study conducted in Idaho from 7 Dec. 2022-8 Feb. 2023.
COUNTS

| | Control | | | CSI 19-305 | | |
|---|---|---|---|---|---|---|
| Study | Mean | 95% CI's | | | 95% CI's | |
| Day | Counts | Lower | Upper | Mean | Lower | Upper |
| −2 | 87 | 0.47 | 2.02 | 0.4 | 0.2 | 1.3 |
| 7 | 99 | 0.79 | 2.96 | 0.0 | — | — |
| 14 | 52 | 0.08 | 0.75 | 0.0 | — | — |
| 21 | 82 | 0.08 | 0.75 | 0.0 | — | — |
| 28 | 49 | 0.03 | 0.55 | 0.0 | — | — |
| 35 | 131 | 0.54 | 2.23 | 0.1 | 0.0 | 0.7 |
| 42 | 86 | 0.05 | 0.65 | 0.2 | 0.0 | 0.8 |
| 49 | 87 | 2.47 | 7.85 | 1.5 | 0.7 | 3.1 |
| 55 | 117 | 1.19 | 4.23 | 1.5 | 0.7 | 3.1 |

SURVIVAL & EFFICACY

| Study | Control | CSI 19-305 | CSI 19-305 | 95% CI's | 95% CI's |
|---|---|---|---|---|---|
| Day | Survival | Survival | Efficacy | Lower | Upper |
| 7 | 125% | 0% | 100% | — | — |
| 14 | 67% | 0% | 100% | — | — |
| 21 | 101% | 0% | 100% | — | — |
| 28 | 62% | 0% | 100% | — | — |
| 35 | 151% | 0.1% | 99.9% | 99.2% | 100.0% |
| 42 | 100% | 0.3% | 99.8% | 99.1% | 100.0% |
| 49 | 106% | 1.8% | 98.3% | 96.9% | 99.1% |
| 55 | 174% | 1.9% | 98.3% | 96.9% | 99.1% |

The test substance was not efficacious against hatching louse eggs. Before treatment, there were no significant differences (overlapping 95% confidence intervals) between the two groups in the numbers and proportions of louse eggs hatching. Post-treatment counts and hatching proportions were significantly different (non-overlapping confidence intervals) between the treated and control animals.

TABLE 14
Least squares mean total louse counts, survival (compared to pretreatment
counts) and efficacy on treated cattle (with 95% confidence intervals).
Study conducted in Idaho from 7 Dec. 2022-8 Feb. 2023.
HATCHED EGG COUNTS

| | Pre-treatment | | | Post-treatment | | |
|---|---|---|---|---|---|---|
| | | 95% CI's | | | 95% CI's | |
| Group | Mean | Lower | Upper | Mean | Lower | Upper |
| Control | 16.7 | 14.4 | 19.4 | 15.9 | 13.7 | 18.4 |
| CSI 19-305 | 19.2 | 16.8 | 21.9 | 21.7 | 19.1 | 24.6 |

% Egg Hatch

| | Pre-treatment | | | Post-treatment | | |
|---|---|---|---|---|---|---|
| | | 95% CI's | | | 95% CI's | |
| Group | Mean | Lower | Upper | Mean | Lower | Upper |
| Control | 67% | 61% | 72% | 64% | 58% | 69% |
| CSI 19-305 | 77% | 71% | 81% | 87% | 82% | 90% |

All animals gained weight during the study (Table 15). There were no significant differences (overlapping 95% confidence intervals) in initial and final body weights, total gain or average daily gain (ADG) between the treated and control groups.

There was one adverse event observed during the study. On 19 Jan. 2023 animal #4 (control group) was observed with lameness and mild swelling in the right hind foot due to foot rot. The animal had recovered by 25 Jan. 2023. This event was determined to be unrelated to the test substance.

The results of this study showed that CSI 19-305 killed lice, suckling lice, and biting/chewing lice. The results also show that the lice were controlled for 8 weeks.

TABLE 15
Animal body weights (lbs.) and weight gain during the study.
Study conducted in Idaho from 7 Dec. 2022-8 Feb 2023.

| | | | | | | | | Group Averages | |
|---|---|---|---|---|---|---|---|---|---|
| Animal Body Weights (lbs.) | | | | | | | | (95% CI) | |
| | | 13 Dec. | Average | 8 Feb. | Average | Total | | Total | |
| Group | Animal | 2022 | (95% CI's) | 2023 | (95% CI's) | Gain | ADG | Gain | ADG |
| Control | 1 | 603 | 651 | 742 | 806 | 139 | 2.4 | 155 | 2.7 |
| | 2 | 664 | (609-692) | 820 | (771-841) | 156 | 2.7 | (130-180) | (2.3-3.2) |
| | 4 | 733 | | 857 | | 124 | 2.2 | | |
| | 9 | 666 | | 855 | | 189 | 3.3 | | |
| | 13 | 640 | | 826 | | 186 | 3.3 | | |
| | 14 | 603 | | 753 | | 150 | 2.6 | | |
| | 17 | 616 | | 751 | | 135 | 2.4 | | |
| | 21 | 632 | | 841 | | 209 | 3.7 | | |
| | 22 | 587 | | 758 | | 171 | 3.0 | | |
| | 24 | 764 | | 856 | | 92 | 1.6 | | |
| CSI 19-305 | 3 | 541 | 644 | 620 | 781 | 79 | 1.4 | 136 | 2.4 |
| | 5 | 681 | (604-685) | 812 | (730-830) | 131 | 2.3 | (111-162) | (2.0-2.8) |
| | 6 | 688 | | 835 | | 147 | 2.6 | | |
| | 11 | 640 | | 800 | | 160 | 2.8 | | |
| | 15 | 636 | | 793 | | 157 | 2.8 | | |
| | 16 | 653 | | 726 | | 73 | 1.3 | | |
| | 18 | 617 | | 791 | | 174 | 3.1 | | |
| | 19 | 620 | | 761 | | 141 | 2.5 | | |
| | 20 | 612 | | 790 | | 178 | 3.1 | | |
| | 23 | 755 | | 879 | | 124 | 2.2 | | |

What is claimed is:

1. A pour-on formulation for controlling pests on animals, the formulation comprising:
a. a pesticidal effective amount of a voltage-dependent sodium channel blocker;
b. a paraffinic oil; and
c. optionally a surface acting agent, a rheology modifier, or both.

2. The pour-on formulation of claim 1, wherein the pesticidal effective amount of voltage-dependent sodium channel blocker in the formulation ranges from about 5% to about 50% by weight.

3. The pour-on formulation of claim 1, wherein the voltage-dependent sodium channel blocker is indoxacarb.

4. The pour-on formulation of claim 3, wherein the pesticidal effective amount of indoxacarb ranges from about 5% to about 15% by weight.

5. The pour-on formulation of claim 1, wherein the paraffinic oil is a normal paraffin, an isoparaffin, a cycloparaffin, a highly refined paraffinic mineral oil, a solvent dewaxed light and/or heavy paraffinic distillate, or mixtures thereof.

6. The pour-on formulation of claim 1, wherein the paraffinic oil is an isoparaffin.

7. The pour-on formulation of claim 1, wherein the paraffinic oil is a mixture of hydrotreated isoparaffins and naphthenics.

8. The pour-on formulation of claim 7, wherein the amount of hydrotreated isoparaffins and naphthenics in the formulation ranges from about 85% to about 95% by weight.

9. The pour-on formulation of claim 7, wherein the paraffinic oil is SASOL LPA 210.

10. The pour-on formulation of claim 1, wherein the surface acting agent is an oil-soluble surfactant.

11. The pour-on formulation of claim 10, wherein the amount of oil-soluble surfactant in the formulation ranges from about 0.5% to about 2% by weight.

12. The pour-on formulation of claim 10, wherein the surface acting agent is Tomadol 23-5.

13. The pour-on formulation of claim 1, wherein the rheological modifier is fumed metal oxide.

14. The pour-on formulation of claim 13, wherein the fumed metal oxide is fumed silicon oxide.

15. The pour-on formulation of claim 13, wherein the fumed metal oxide is hydrophobic/hydrophilic fumed silicon oxide.

16. The pour-on formulation of claim 10, wherein the amount of fumed silicon oxide in the formulation ranges from about 1.0% to about 5.0% by weight.

17. The pour-on formulation of claim 14, wherein the fumed metal oxide is CAB-O-SIL.

18. The pour-on formulation of claim 1, wherein the animals are cattle.

19. The pour-on formulation of claim 1, wherein the pests are ectoparasites.

20. The pour-on formulation of claim 1, wherein the pests are horn flies.

21. The pour-on formulation of claim 1, wherein the pests are lice.

22. A pour-on formulation for control of pests on an animal, the formulation comprising:
a. indoxacarb in an amount ranging from about 5% to about 50% by weight;
b. a mixture of hydrotreated isoparaffins and naphthenics in an amount ranging from about 85% to about 95% by weight;
c. an oil-soluble surfactant in an amount ranging from about 0.5% to about 2% by weight; and
d. fumed silicon oxide in an amount ranging from about 1.0% to about 5.0% by weight.

23. A method of controlling pest infestations in animals, the method comprising pouring onto the external skin of the animal to be treated an effective amount of a pour-on formulation for control of pests on animals of claim 1, wherein the formulation is capable of diffusing over the body of the domestic animal when applied to a localized region of the domestic animal, thereby protecting the animal from pests.

24. A kit for controlling pests in animals, the kit comprising a pour-on formulation for control of pests on an animal of claim 1.
